(19) United States
(12) Patent Application Publication
(10) Pub. No.: US 2019/0214001 A1
(43) Pub. Date: Jul. 11, 2019

(54) VOICE CONTROL INPUT SYSTEM

(71) Applicant: THERMALTAKE TECHNOLOGY CO., LTD., TAIPEI CITY (TW)

(72) Inventor: PEI-HSI LIN, TAIPEI CITY (TW)

(21) Appl. No.: 15/996,627

(22) Filed: Jun. 4, 2018

(30) Foreign Application Priority Data
Jan. 5, 2018 (TW) 107200206

(51) Int. Cl. G10L 15/22; G10L 15/26

(52) U.S. Cl. CPC G10L 15/22; G10L 2015/223; G10L 15/265

(57) ABSTRACT

A voice control input system has a control device, a computer and at least one computer peripheral device. An application program is installed in the control device. The computer connected to the control device has a driver installed therein. The computer peripheral device connected to the computer is driven by the driver. The application program has voice recognition function for allowing the control device to generate a corresponding operation signal according to a voice input received by the control device. The driver allows the computer to convert the operation signal into at least one control signal according to a pre-stored data of the driver, and the computer peripheral device receives the control signal to perform an action accordingly. Therefore, the voice control input system can use the voice input received by the control device to control the computer peripheral device(s) to perform an action.

### CROSS REFERENCE

The present disclosure claims the priority benefit of Taiwan Patent Application Number 107200206, filed Jan. 5, 2018. The disclosure of the prior patent application is incorporated herein by reference.

### TECHNICAL FIELD

The disclosure is related to a voice control input system, and more particularly to a voice control input system that uses a voice input received by a control device to control a computer peripheral device or a computer to perform a corresponding action.

### RELATED ART

A computer peripheral device may include a keyboard, a mouse, a joystick, a fan, and an audio device (such as a headphone, a speaker, and so on). The computer peripheral device is connected to an input/output unit of the computer to receive control signals from the computer or generate output signals to the computer.

For example, a light-emitting keyboard can be an output/input device connected to a computer through a USB, and can be driven by a driver installed on the computer. For example, a light-emitting action of the light-emitting keyboard can be controlled by the control signal which the user inputs to the light-emitting keyboard. For another example, after the user performs a specific action on the light-emitting keyboard (e.g. sequentially hitting keys “W”, “A”, “S”, and “D” of the light-emitting keyboard), the light-emitting keyboard generates a group of output signals corresponding to the specific action, and the group of output signals is transmitted to the computer via the input/output unit.

There are restrictions on how to use existing computers and existing peripheral devices together. For example, if a physical key or a physical button on a keyboard, a mouse, or a joystick is hit or pressed, only a letter, a symbol, or an instruction can be generated. For another example, an input operation of a user can be inconvenient in some cases, because physical keys or physical buttons on a keyboard, a mouse, and a joystick are in fixed positions.

### SUMMARY

In order to solve the above problems of the prior art or other problems, an objective of the present disclosure is to provide a voice control input system having a control device connected to a computer, so as to control the computer or a computer peripheral device in response to a voice input of a user.

To achieve the above and other objectives, the present disclosure provides a voice control input system, comprising a control device, a computer, and at least one computer peripheral device. The control device is installed with an application program. The computer is connected to the control device and installed with a driver. The computer peripheral device is connected to the computer and driven by the driver. The application program has a voice recognition function, which allows the control device to generate an operation signal according to a voice input received by the control device. The driver allows the computer to convert the operation signal into at least one control signal according to a pre-stored data. The computer peripheral device receives the control signal to perform an action accordingly.

In an embodiment, the operation signal includes a converted text message converted from the voice input.

In an embodiment, the action generated performed by the computer peripheral device according to the control signal is an input action, and the computer peripheral device transmits at least one output signal generated in response to the input action to an input/output unit of the computer.

In an embodiment, the driver allows the computer to convert the operation signal into the control signals according to the pre-stored data, and the control signals are to be sequentially executed.

In an embodiment, the computer has a setting interface for setting the pre-stored data of the driver, and the pre-stored data includes a recognizing text message capable of recognizing the voice input.

In an embodiment, the number of the computer peripheral devices is more than one, and the driver allows the computer to convert the operation signal into the control signals according to the pre-stored data and send control signals to the different computer peripheral devices.

In an embodiment, if a specific event occurs in the application program executed by the computer, the computer generates a feedback command to the control device through the driver.

In an embodiment, the computer peripheral device includes a keyboard.

In an embodiment, the computer peripheral device includes a mouse.

In an embodiment, the computer peripheral device includes a joystick.

To achieve the above and other objects, the present disclosure provides another one voice control input system, comprising a control device and a computer. The control device is installed with an application program. The computer is connected to the control device and installed with a driver. At least one input device of the computer is driven by the driver. The application program has a voice recognition function for allowing the control device to generate an operation signal according to a voice input received by the control device. The driver allows the computer to convert the operation signal into at least one control signal according to the pre-stored data. The input device receives the control signal to perform an input action accordingly.

In an embodiment, the operation signal includes a converted text message converted from the voice input.

In an embodiment, the driver allows the computer to convert the operation signal into the control signals according to pre-stored data, and the control signals are to be sequentially executed.

In an embodiment, the computer further includes a host device, the host device is connected to the input device, and the host device receives at least one output signal generated in response to the input action of the input device.

In an embodiment, the host device has a setting interface for setting pre-stored data of the driver, and the pre-stored data includes a recognizing text message capable of recognizing the voice input.

In an embodiment, if a specific event occurs in the application program executed by the host device, the host device generates a feedback command to the control device through the driver.

In an embodiment, the input device includes a keyboard.

In an embodiment, the input device includes a mouse.

In an embodiment, the input device includes a joystick.

To sum up, the voice control input system of the present disclosure controls the computer or the computer peripheral device to perform an action in response to a voice input received by the control device.

### BRIEF DESCRIPTION OF THE DRAWINGS

FIG. 1 is a system block diagram of a voice control input system according to an embodiment of the present disclosure;

FIG. 2 is a schematic sequence diagram of a communication between components in a voice control input system according to an embodiment of the present disclosure;

FIG. 3 is a schematic sequence diagram of a communication between components in a voice control input system according to another embodiment of the present disclosure;

FIG. 4 is a schematic sequence diagram of a communication between components in a voice control input system according to another embodiment of the present disclosure;

FIG. 5 is a schematic diagram of a driver program running on a computer of a voice control input system according to an embodiment of the present disclosure;

FIG. 6 is a system block diagram of a voice control input system according to another embodiment of the present disclosure;

FIG. 7 is a schematic sequence diagram of a communication between components in a voice control input system according to another embodiment of the present disclosure; and

FIG. 8 is a schematic sequence diagram of a communication between components in a voice control input system according to another embodiment of the present disclosure.

### DETAILED DESCRIPTION

In order for persons skilled in the art to fully understand the objective, characteristics, and efficacy of the present disclosure, a detailed explanation of the present disclosure is given by the following specific examples and in conjunction with the accompanying drawings.

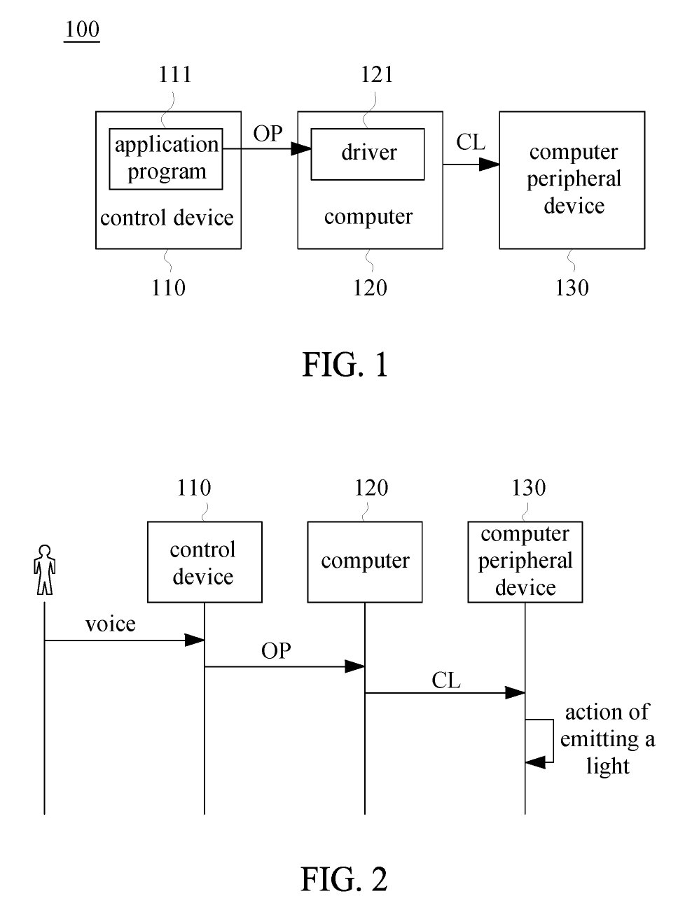

Referring to FIG. 1, FIG. 1 is a system block diagram of a voice control input system according to an embodiment of the present disclosure. The voice control input system 100 includes a control device 110, a computer 120, and at least one computer peripheral device 130. The control device 110 is installed with an application program 111. The computer 120 is connected to the control device 110 and is installed with a driver 121. The computer peripheral device 130 is connected to the computer 120 and is driven by the driver 121.

The application program 111 runs on the control device 110. The application program 111 has a voice recognition function to enable the control device 110 to generate an operation signal OP according to a voice input received by the control device 110. The driver 121 runs on the computer 120. The driver 121 allows the computer 120 to convert the operation signal OP into at least one control signal CL according to a pre-stored data of the driver. The computer peripheral device 130 receives the control signal CL to perform an action accordingly.

In a preferred embodiment, the application program 111 can utilize voice recognition to convert a voice input of a user into a converted text message. The control device 110 transmits an operation signal OP including the converted text message to the computer 120. The driver 121 of the computer 120 analyzes whether the converted text message is a recognizable voice according to the pre-stored data (for example, comparing “the converted text message” and “recognizing text message(s)” preset in the pre-stored data, wherein the recognizing text message is capable of recognizing the voice input to generate the control signal). If an analyzing result is true, the control device 110 is caused to convert the operation signal OP into the control signal CL.

In another preferred embodiment, the application program 111 can use voice recognition to compare a voice input of a user and pre-stored voices to determine whether the voice input of the user is recognizable (e.g. analyzing the he loudness, the pitch and the fret of the voice input). If an analyzing result is true, the control device 110 transmits the operation signal OP corresponding to the recognizable voice to the computer 120. The driver 121 allows the computer 120 to convert the operation signal OP into the control signal CL according to the pre-stored data. Therefore, the present disclosure is not limited to the recognizing method of converting a voice input into a converted text message, and the present disclosure can also use a recognizing method of direct comparison voice input and pre-stored voices. However, the recognizing method of converting a voice input into a converted text message has some technical advantages over other recognizing methods.

Referring to FIG. 2, FIG. 2 is a schematic sequence diagram of a communication between components in a voice control input system according to an embodiment of the present disclosure.

In the embodiment of FIG. 2, the application program 111 of the control device 110 can recognize the voice as “keyboard red”. When the user speaks “keyboard red”, the control device 120 generates an operation signal OP according to an analyzing result of the voice recognition (the operation signal OP may or may not include the converted text message “keyboard red” depending on the recognizing method used). The driver 121 allows the computer 120 to convert the operation signal OP into the control signal CL according to the pre-stored data. The computer peripheral device 130 (such as, keyboard) receives the control signal CL to perform the action of emitting red light.

In the embodiment of FIG. 2, the control device 110 is a mobile phone or a tablet, the computer 120 is a desktop computer, and the computer peripheral device 130 is a keyboard. However, the control device 110, the computer 120 and the computer peripheral device 130 of the present disclosure are not limited to these devices.

For example, the control device 110 can be a control device other than a mobile phone or a tablet that can be installed with the application program. The computer 120 can be a notebook or other driver-executable computer device. The computer peripheral device 130 can be a mouse, a joystick, or an audio device (e.g. a headphone or a speaker). In addition, the computer 120 and the computer peripheral device 130 can be implemented as a plurality of standalone devices, or as the same device. For example, when the computer 120 is a notebook and the computer peripheral device 130 includes a keyboard and a touchpad, the keyboard and the touchpad can be two separate devices and wired/wirelessly connected to the notebook. Therefore, a total of three standalone devices are used to implement the computer 120 and the computer peripheral device 130. Alternatively, the keyboard and the touchpad can be combined with the notebook to be implemented as the same device.

For example, the recognizable voice is not limited to “keyboard red”, nor is the number of the recognizable voice limited to one. For example, when the user speaks one of the three voices of “keyboard blue”, “keyboard yellow”, and “keyboard green”, the light-emitting keyboard emits light of specified color by the communication sequence of the components as shown in FIG. 2.

For example, the number of the computer peripheral devices 130 can be more than one. For example, the computer peripheral devices 130 can include a light-emitting keyboard, a fan, and an audio device. When the user speaks a specific voice, the light emitting keyboard and the fan each emit a specific color of light and the audio device plays a specific sound.

The recognizable voice of the present embodiment (although the number of the recognizable voice is taken one as an example, but not limited thereto) is pre-stored in the driver 121 by data. Therefore, when the user speaks a specific voice, the driver 121 can generate a control signal CL (which may or may not include a converted text message) to the computer peripheral device 130 in time. The pre-stored data in the application program 111 or the driver 121 may be set to be fixed and unmodifiable, or may be set to be freely adjustable or defined by a user. The following embodiments will be described in more detail.

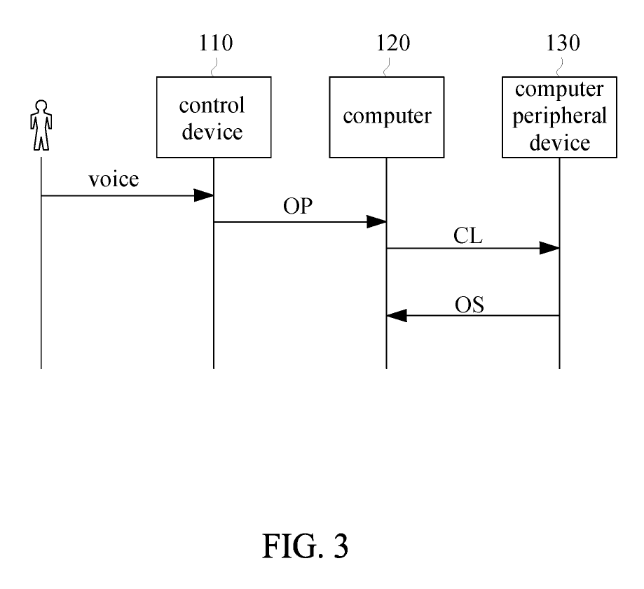

Referring to FIG. 3, FIG. 3 is a schematic sequence diagram of a communication between components in a voice control input system according to another embodiment of the present disclosure.

In the embodiment of FIG. 3, the application program 111 of the control device 110 has eight recognizable voices, which are “up”, “down”, “left”, “right”, “X”, “Y”, “A” and “B”. The eight recognizable voices respectively correspond to the eight physical keys of the computer peripheral device 130 (joystick), which are “↑”, “↓”, “←”, “→”, “X”, “Y”, “A” and “B”. When the user speaks one of the eight recognizable voices, the control device 110 generates an operation signal OP according to the voice recognition result (the operation signal OP may or may not include a converted text message, depending on the analyzing method used). The driver 121 allows the computer 120 to convert the operation signal OP into the control signal CL according to the pre-stored data. The computer peripheral device 130 (such as, joystick) receives the control signal CL to perform an action (e.g. action of generating a corresponding one of the output signals in the present embodiment). An output signal OS generated in response to the voice input action is transmitted to the input/output unit of the computer 120.

The number of recognizable voices is designed to be exactly the same as the number of physical keys of the computer peripheral device 130 (such as, joystick) in the present embodiment. Therefore, the control device 110 can replace the computer peripheral device 130 (such as, joystick), that is, the user can directly input the voice to the control device 110 without having to input through the computer peripheral device 130 (such as, joystick).

In the present embodiment, the voice input is used to replace the pressing or tapping input of physical keys of the computer peripheral device 130 (such as, joystick) which the positions of physical keys cannot be adjusted. Therefore, the present embodiment has an advantage, that is, it brings convenience to a user operation.

In the embodiment of FIG. 3, the control device 110 is a mobile phone or a tablet, the computer 120 is a desktop computer, and the computer peripheral device 130 is a joystick. The number of the recognizable voice is eight, but the present disclosure is not limited thereto.

For example, the control device 110 can be a control device other than a mobile phone or a tablet that can install the application program. The computer 120 can be a notebook or other driver-executable computer device. The computer peripheral device 130 can be a mouse, a joystick, or an audio device (e.g. a headphone or a speaker). In addition, the computer 120 and the computer peripheral device 130 can be implemented as a plurality of standalone devices, or as the same device. For example, when the computer 120 is a notebook and the computer peripheral device 130 includes a keyboard and a touchpad, the keyboard and the touchpad can be two separate devices and wired/wirelessly connected to the notebook. Therefore, a total of three standalone devices are used to implement the computer 120 and the computer peripheral device 130. Alternatively, the keyboard and the touchpad can be combined with the notebook to be implemented as the same device.

For example, the number of the recognizable voices of the control device 110 can be less than the number of the physical keys of the computer peripheral device 130. For example, if a computer software (such as a game) is executed on the computer 120, except for the four physical keys “↑”, “↓”, “←”, and “→” on the keyboard, other physical keys are useless (that is, the tapping of other physical keys does not correspond to any game operation instruction), the control device 110 can recognize the voice input “upper”, “lower”, “left”, and “right” to replace the four physical keys such as “↑”, “↓”, “←” and “→” on the keyboard.

For example, when the number of the computer peripheral devices 130 is more than one, the number of the recognizable voices of the control device 110 can be more than the number of the physical keys of the one or more computer peripheral device 130. For example, the control device 110 can recognize eight recognizable voices, wherein four of them respectively replace four physical keys “W”, “A”, “S”, and “D” on the keyboard, and the other four of them respectively replace a left mouse button, a middle mouse button (sliding scroller), a right mouse button, and a pointer movement function of the mouse. In this example, the number of recognizable voices of the control device 110 (that is, eight) is greater than the number of the physical keys of the mouse (that is, three).

Similarly, the eight recognizable voices of the present embodiment are pre-stored in the driver 121 as the pre-stored data. Therefore, when the user speaks a specific voice, the driver 121 can generate a control signal CL (which may or may not include a converted text message) to the computer peripheral device 130 in time. The pre-stored data in the application program 111 or the driver 121 may be set to be fixed and unmodifiable, or may be set to be freely adjustable or defined by a user. The following embodiments will be described in more detail.

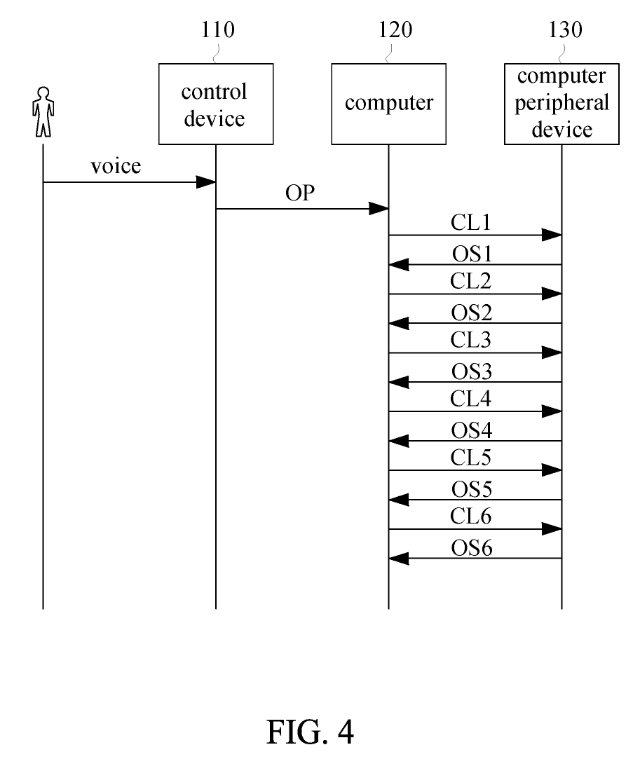

Referring to FIG. 4, FIG. 4 is a schematic sequence diagram of a communication between components in a voice control input system according to another embodiment of the present disclosure.

In the embodiment of FIG. 4, the application program 111 of the control device 110 can recognize the voice as “attack”. When the user speaks “attack”, the control device 120 generates an operation signal OP according to an analyzing result of the voice recognition (the operation signal OP may or may not include the converted text message “attack” depending on the recognizing method used). The driver 121 allows the computer 120 to convert the operation signal OP into the control signals CL1-CL6 according to the pre-stored data. The computer peripheral device 130 (such as, joystick) receives the control signals CL1-CL6 to perform an action (e.g. action of generating a corresponding set of output signals). The set of output signals OS1 to OS6 generated by the voice input action are respectively transmitted to the input/output unit of the computer 120, and the present disclosure is not limited thereto. For example, the number of the output signals can be more or less than six. For example, the control signals CL1-CL6 can be synchronously transmitted to the computer peripheral device 130 or the control signals CL1-CL6 can be combined for generating a control signal.

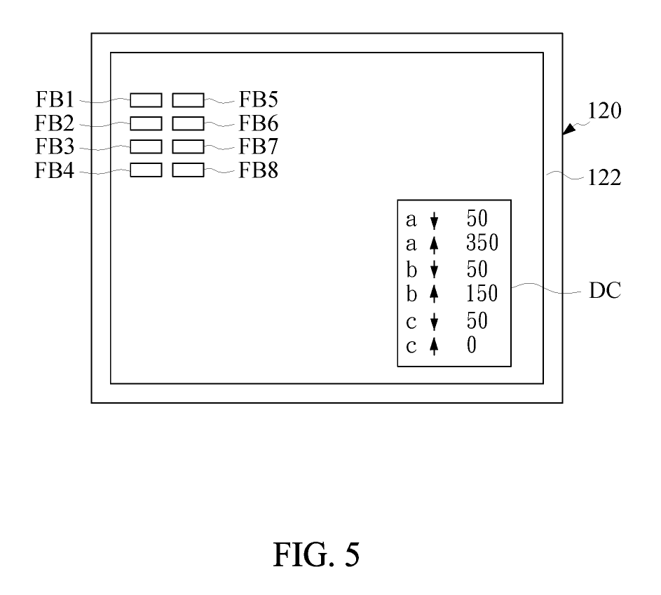

The recognizable voice “attack” of this embodiment is a set of actions for simulating the computer peripheral device 130 (such as, joystick). With reference to a description column DC of FIG. 5, the set of actions can be decomposed into six instructions. The first instruction is to press physical keys “a” and “↓” simultaneously and delay for 50 milliseconds. The second instruction is to press physical keys “a” and “↑” simultaneously and delay for 350 milliseconds. The third instruction is to simultaneously press physical buttons “b” and “↓” and delay for 50 milliseconds. The fourth instruction is to press physical keys“b” and “↑” simultaneously and delay for 150 milliseconds. The fifth instruction is to press physical keys “c” and “↓” simultaneously and delay for 50 milliseconds. The sixth instruction is to press physical keys “c” and “↑” simultaneously and has no delay times. The first to sixth instructions can be executed sequentially.

In this embodiment, a set of actions can be generated by the control device 110 through a one-time voice recognition result of a recognizable voice “attacking” speaking from a user. Compared to the case where the user manually presses the computer peripheral device and only one action can be generated for each press and the duration of the press (i.e. the delay time) may not be accurate, this embodiment can easily meet more complex and more precise operation requirements.

In the embodiment of FIG. 4, the control device 110 is a mobile phone or a tablet, the computer 120 is a desktop computer, and the computer peripheral device 130 is a joystick. However, the present disclosure is not limited thereto.

For example, the control device 110 can be a control device other than a mobile phone or a tablet that can install the application program. The computer 120 can be a notebook or other driver-executable computer device. The computer peripheral device 130 can be a mouse, a joystick, or an audio device (e.g. a headphone or a speaker). In addition, the computer 120 and the computer peripheral device 130 can be implemented as a plurality of standalone devices, or as the same device. For example, when the computer 120 is a notebook and the computer peripheral device 130 includes a keyboard and a touchpad, the keyboard and the touchpad can be two separate devices and wired/wirelessly connected to the notebook. Therefore, a total of three standalone devices are used to implement the computer 120 and the computer peripheral device 130. Alternatively, the keyboard and the touchpad can be combined with the notebook to be implemented as the same device.

For example, the recognizable voice is not limited to “attacks”, nor is the number of the recognizable voices limited to one. For example, the recognizable voices can include “attack”, “defense”, and the like. Each set of output signals generated by each recognizable voice can be different. When the user speaks one of the recognizable voices, the recognized speech can be generated by its communication sequence as shown in FIG. 4 to generate a set of output signals.

For example, the number of recognizable voices can be designed to be the same as or different from the number of physical keys of the computer peripheral device 130. The number of the computer peripheral devices 130 can be more than one.

The number of recognizable voices in the embodiments of FIG. 2 to FIG. 4 and the actions (i.e. control effects) to be generated according to the voice recognition results can be freely adjusted or defined by a user. The pre-stored data setting interface 122 of the driver 121 of the computer 120 is shown in FIG. 5. On the right side of the drawing in FIG. 5, a description column DC is provided. Each description column DC can record one or a set of actions corresponding to one of the recognized voices. On the left side of the drawing in FIG. 5, a plurality of function buttons FB1 to FB8 are provided. When being clicked, the function buttons FB1 to FB8 can be used to realize a storage, a clearing, a copying, an output, an input from description column of another recognizable voice(s), an increase or decrease of the number of recognizable voices, a modifying of contents of the recognizing text message (can be modified to any Chinese words or sentences, English words or sentences, words or sentences in other languages, combinations of words or sentences in different languages, etc.) of the recognizable voices, a setting of delay time, and other functions.

In addition, the voice control input system of the present disclosure can have a reminding function. Specifically, when computer software (e.g. a game) is executed on the computer 120, the computer 120 can generate a feedback instruction if a specific event occurs in the computer software (e.g. a game character dies or a car is crashed). The feedback instructions can be transmitted back to the control device 110 via the driver 121. Upon receiving the feedback instruction, the control device 110 can alert the user of the occurrence of the specific event by generating a shock or by other means.

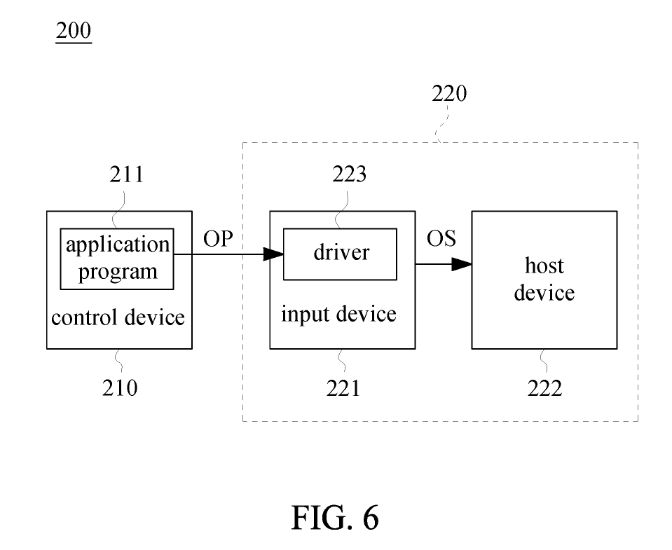

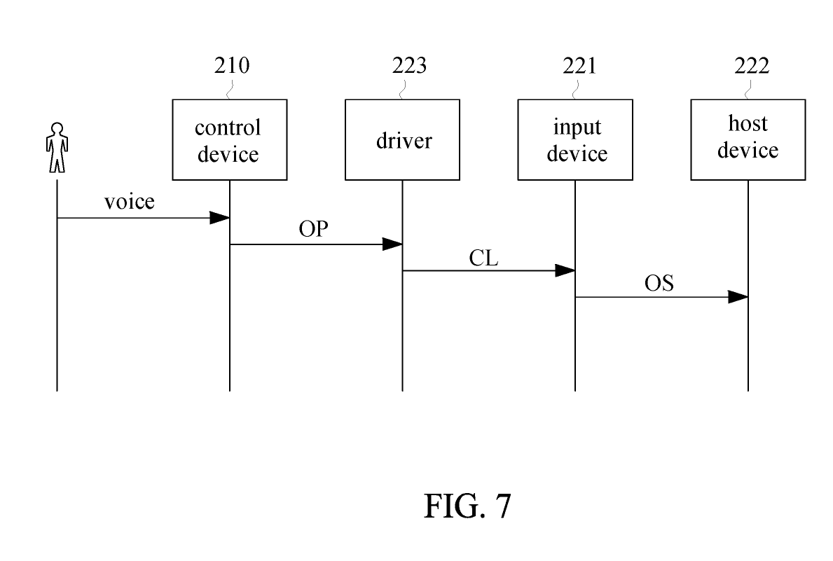

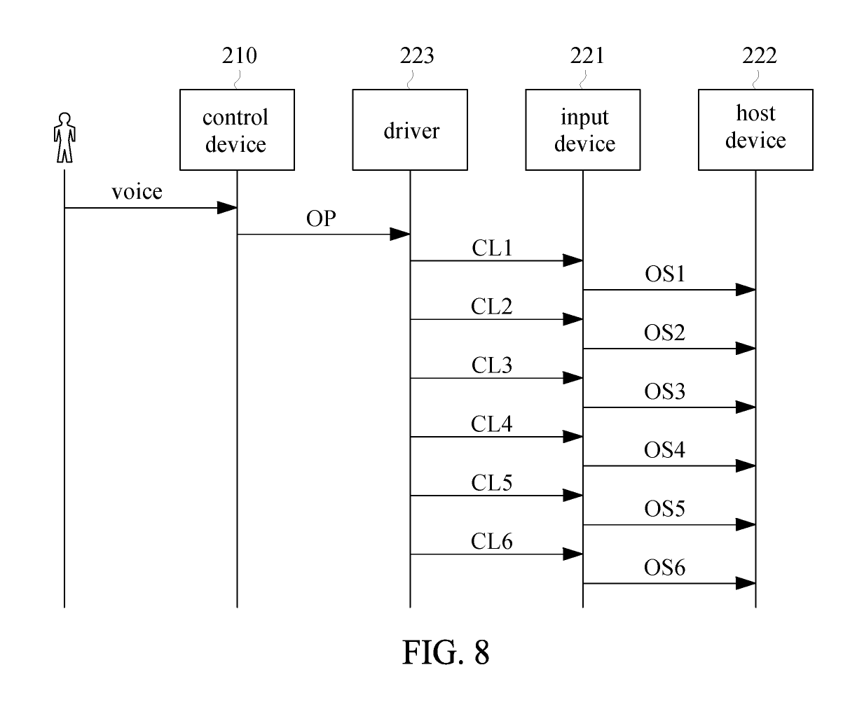

Please refer to FIGS. 6 to 8, FIG. 6 is a system block diagram of a voice control input system according to another embodiment of the present disclosure, FIG. 7 is a schematic sequence diagram of a communication between components in a voice control input system according to another embodiment of the present disclosure, and FIG. 8 is a schematic sequence diagram of a communication between components in a voice control input system according to another embodiment of the present disclosure.

A voice control input system 200 includes a control device 210 and a computer 220. The control device 210 is installed with an application program 211. The computer 220 includes at least one input device 221, a host device 222, and a driver 223. The input device 221 is installed with a driver 223 and is driven by the driver 223.

The application program 211 runs on the control device 210. The application program 211 has a voice recognition function to enable the control device 210 to generate an operation signal OP according to a voice input of the control device 210. The driver 223 runs on the computer 220. The driver 223 allows the computer 220 to convert the operation signal OP into a control signal CL according to the pre-stored data. The input device 221 receives the control signal CL to perform an action accordingly. The host device 222 receives an output signal OS generated by an input operation of the input device 221.

The main difference between the voice control input system 200 and the voice control input system 100 is that the driver 223 is directly mounted in the input device 221. The host device 222 dispenses with the driver 223 otherwise mounted thereon. Therefore, comparison of FIGS. 3, 7 and comparison of FIGS. 4, 8 shows that a communication between components of the voice control input system 200 differs from a communication between components of the voice control input system 100 slightly.

For example, the control device 210 can be a mobile phone, a tablet or any other control device that can be installed with the application program. The input device 221 can include a keyboard, a mouse, a joystick, and the like. The computer 120 can be a desktop computer, a notebook or other computer device. The input device 221 and the host device 222 can be connected via a wired/wireless connection.

The components, the detailed components, or the signals of the voice control input system 200 have roughly the same ways and functions as the components, the detailed components or the signals of the voice control input system 100 if they have the same component name. Further, possible variations of the voice control input system 200 are also roughly the same as the aforementioned possible variations of the voice control input system 100. Therefore, a detailed description of the voice control input system 200 will not be described here.

To sum up, the voice control input system of the present disclosure controls the computer or the computer peripheral device to perform an action in response to a voice input received by the control device.

The present disclosure is illustrated by preferred embodiments, but it should be understood by those of ordinary skill in the art to which this disclosure pertains that these embodiments are only for the purpose of depicting the present disclosure and should not be construed as limiting the present disclosure. It should be noted that any changes and substitutions equivalent to those of the embodiments should be deemed falling within the scope of the present disclosure. Hence, the scope of protection for the present disclosure shall be subject to the definition of the scope of the accompanying claims.

What is claimed is:

1. A voice control input system, comprising:
a control device having thereon an application program installed;
a computer connected to the control device and installed with a driver; and
at least one computer peripheral device connected to the computer and driven by the driver;
wherein the application program has a voice recognition function, the recognition function allowing the control device to generate an operation signal according to a voice input of the control device, and the computer converts the operation signal into at least one control signal according to a pre-stored data by the driver, thereby allowing the computer peripheral device to receive the control signal and perform an action accordingly.

2. The voice control input system according to claim 1, wherein the operation signal includes a converted text message converted from the voice input.

3. The voice control input system according to claim 2, wherein the action performed by the computer peripheral device according to the control signal is an input action, and the computer peripheral device transmits at least one output signal generated in response to the input action to an input/output unit of the computer.

4. The voice control input system according to claim 3, wherein the control signals are to be sequentially executed after the computer has converted the operation signal into the control signals according to the pre-stored data by the driver.

5. The voice control input system according to claim 4, wherein the computer has a setting interface for setting the pre-stored data of the driver, and the pre-stored data includes a recognizing text message capable of recognizing the voice input.

6. The voice control input system according to claim 1, wherein the number of the computer peripheral devices is more than one, and the driver allows the computer to convert the operation signal into the control signals according to the pre-stored data and send control signals to the different computer peripheral devices.

7. The voice control input system according to claim 1, wherein, if a specific event occurs in the application program executed by the computer, the computer generates a feedback command to the control device through the driver.

8. The voice control input system according to claim 1, wherein the computer peripheral device includes a keyboard.

9. The voice control input system according to claim 1, wherein the computer peripheral device includes a mouse.

10. The voice control input system according to claim 1, wherein the computer peripheral device includes a joystick.

11. A voice control input system, comprising:
a control device having thereon an application program installed; and
a computer connected to the control device and installed with a driver for driving at least one input device of the computer;
wherein the application program has a voice recognition function, the voice recognition function allowing the control device to generate an operation signal according to a voice input received by the control device, and the computer converts the operation signal into at least one control signal according to a pre-stored data by the driver, thereby allowing the input device to receive the control signal and perform an input action accordingly.

12. The voice control input system according to claim 11, wherein the operation signal includes a converted text message converted from the voice input.

13. The voice control input system according to claim 12, wherein the control signals are to be sequentially executed after the computer has converted the operation signal into the control signals according to the pre-stored data by the driver.

14. The voice control input system according to claim 11, wherein the computer further includes a host device connected to the input device and adapted to receive at least one output signal generated in response to the input action performed by the input device.

15. The voice control input system according to claim 14, wherein the host device has a setting interface for setting the pre-stored data of the driver, and the pre-stored data includes a recognizing text message capable of recognizing the voice input.

16. The voice control input system according to claim 15, wherein the operation signal includes a converted text message converted from the voice input.

17. The voice control input system according to claim 14, wherein, if a specific event occurs in the application program executed by the host device, the host device generates a feedback command to the control device through the driver.

18. The voice control input system according to claim 11, wherein input device includes a keyboard.

19. The voice control input system according to claim 11, wherein the input device includes a mouse.

20. The voice control input system according to claim 11, wherein the input device includes a joystick.
